(19) United States
(12) Patent Application Publication
(10) Pub. No.: US 2008/0180078 A1
(43) Pub. Date: Jul. 31, 2008

(54) SWITCHING POWER SUPPLY AND METHOD OF CONTROLLING THEREOF

(75) Inventor: Nobuyuki HIASA, Matsumoto City (JP)

Correspondence Address: ROSSI, KIMMS & McDOWELL LLP., P.O. BOX 826, ASHBURN, VA, 20146-0826, US

(73) Assignee: FUJI ELECTRIC DEVICE TECHNOLOGY CO., LTD., Tokyo (JP)

(21) Appl. No.: 12/022,077

(22) Filed: Jan. 29, 2008

(30) Foreign Application Priority Data
Jan. 30, 2007 (JP) 2007-018686

(51) Int. Cl. G05F 1/10

(52) U.S. Cl. 323/282

(57) ABSTRACT

The switching power supply can reduce electric power consumption in the standby mode, while preventing overcurrent at the start of the switching power supply, as well as providing protection against short-circuiting. The switching power supply includes a switching control circuit that provides a PFM control when a light-load judging section thereof judges based on a feedback signal that the load is light, a PWM control when light-load judging section thereof judges based on the feedback signal that the load is not light, setting the minimum ON-period of a switching device when the predetermined condition is met during the PWM control such that the minimum ON-period during the PWM control is shorter than the ON-period of the switching device during the PFM control, and turning off the switching device when the current flowing through the switching device exceeds the allowable value to the higher side after the elapse of the minimum ON-period.

### BACKGROUND

Reducing electric power consumption in electric and electrical instruments is highly desirable especially considering the effects on the environment. There is a pressing demand for the OA instruments and those instruments that have a standby function to reduce electric power consumption. Even with the standby function, there remains a need to further reduce electric power consumption while in the standby mode.

To reduce electric power consumption in the standby mode, a system that uses a power supply having a large capacity in the normal operation mode and a standby power supply in the standby mode has been employed. However, such a system widens their occupied area since it uses two power supplies and increases its manufacturing costs. Therefore, it is difficult to realize a system that uses two power supplies while keeping the cost low.

A system that employs one power supply while reducing electric power consumption in the standby mode is known. Such a system employs a switching power supply and lowers the driving frequency (switching frequency) of the power MOSFET used as a switching device in the standby mode. For lowering the switching frequency, two methods have been employed. One of the methods changes over the switching frequency to a lower side as the load current exceeds a reference value. That is, the switching frequency changes stepwise between two values. The other method lowers the switching frequency in response to the load current as the load current exceeds the reference value. That is, the switching frequency changes continuously in response to the load current lower than the reference value.

FIG. 12 is a block circuit diagram of the switching power supply described above. Here, the alternating current from an AC power supply AP1 is full-wave rectified by a diode stack DS1 and smoothed by a capacitor C1 to produce a direct current. The direct current is fed to a primary winding N1 of an output transformer T1. A power MOS transistor Q1 working as a switching device is connected in series to the primary winding N1. The power MOS transistor Q1 is switched ON and OFF by the driving signal fed from a switching control circuit 100 integrated into an IC. The ON and OFF switching of the power MOS transistor Q1 generates a pulsating current in a secondary winding N2 of the output transformer T1. The pulsating current is rectified by a diode D1, smoothed by a capacitor C2, and fed to a load (not shown).

The output voltage to the load is detected by resistors R1 through R3. The detected output voltage value is input to an FB terminal of the switching control circuit 100 as a feedback signal via a photocoupler PC1. As current flows through the primary winding N1 of the output transformer T1, voltage is generated across an auxiliary winding N3. The voltage across the auxiliary winding N3 is rectified by a diode D2, smoothed by a capacitor C3, and fed to a Vcc terminal, which is the power supply terminal of the switching control circuit 100.

The detection signal of the current that flows through the power MOS transistor Q1 is input to an IS terminal of the switching control circuit 100. FIG. 12 also illustrates a ground terminal GND, a fuse F1, a capacitor C4, and a shunt regulator SR1. A limiting resistor R4 limits the current from the high-voltage system. A filtering resistor R5 reduces the noises flowing to the IS terminal. A detecting resistor R6 detects the current that flows through the power MOS transistor Q1. A resistor R7 adjusts the current for driving the gate of the power MOS transistor Q1. A resistor R8 adjusts the current that flows through the photocoupler PC1.

For adjusting the normal output voltage to a certain value, the switching power supply configured as described above monitors the output voltage, feeds back the output voltage data to the switching control circuit that drives the switching device, and conducts a pulse-width-modulation (PWM) control to regulate the pulse width of the switching device. In short, the switching power supply configured described above conducts a negative feedback control.

Feeding too much current to the load creates an overfeed, raising the output voltage. As the output voltage rises, the data indicating the overfeed appears in the feedback signal. As the switching control circuit pinches the current feed, the output voltage lowers. When output voltage lowers in contrast, the control in the opposite direction is conducted in the same flow as described above to adjust the output voltage to a certain value.

The method described above, which lowers the switching frequency in response to the load current, uses the feedback signal as the alternative data, which indicates the magnitude or the increase and decrease of the load current, and changes the switching frequency based on the alternative data.

Switching control circuits that judge the load weight, conduct a PWM control under a heavy load (i.e., when the load is heavier than a certain value), and conduct a pulse-frequency-modulation (PFM) control under a light load to improve the electric power conversion efficiency under the light load, are known. See Unexamined Japanese Patent Application Publication No. 2003-319645 (Paragraphs [0012], [0045] through [0047], FIGS. 12 and 20) (hereafter Reference 1), Unexamined Japanese Patent Application Publication No. 2004-96982 (Paragraphs [0002] through [0027], [0056] through [0073], FIG. 1, FIGS. 5-7) (hereafter Reference 2), and Unexamined Japanese Patent Application Publication No. 2006-149067 (Paragraphs [0002] through [0017], [0030], [0031], FIG. 1, FIGS. 8-12) (hereafter Reference 3).

The switching control circuit disclosed in Reference 1 compares the current flowing through the switching transistor or the amplified error signal with the reference value for judging the load weight. The switching control circuit disclosed in Reference 2 compares the current flowing through the switching transistor with a reference value for judging the load weight. The switching control circuit disclosed in Reference 3 estimates the load weight from the current flowing through the switching transistor. FIGS. 13 and 14 shows the configurations of the switching control circuits that judge the load weight for conducting a switching control as described above.

FIG. 13 is a block diagram of a conventional switching control circuit that conducts a voltage mode of control. Here, a light-load judging section 101 judges whether the load is light or not based on a feedback signal VFB. When the light-load judging section 101 judges that the load is light, the light-load judging section 101 inputs a signal at a high level (hereinafter referred to as an “H-level” or simply as an “H”) to selection a signal input terminal S of a multiplexer 104. When the light-load judging section 101 judges that the load is not light, the light-load judging section 101 inputs a signal at a low level (hereinafter referred to as an “L-level” or simply as an “L”) to selection the signal input terminal S of the multiplexer 104. The light-load judging section 101 controls the frequency of an oscillator 102 as described above corresponding to the load weight. The feedback signal VFB is low when the output voltage from the switching power supply is high and high when the output voltage from the switching power supply is low. A PWM comparator CP101 compares the feedback signal VFB with the oscillation signal from the oscillator 102. The output signal from the PWM comparator CP101 that indicates the comparison result is input directly and via a PFM one-shot circuit 103 to the multiplexer 104.

When the load is light, the output signal from the light-load judging section 101 is set at H and the output from the multiplexer 104 is set to be the output signal from the PFM one-shot circuit 103. In this case, the PFM control is conducted by changing the oscillation frequency of the oscillator 102. When the load is not light, the output from the multiplexer 104 is set to be the output signal from the PWM comparator CP101. In this case, the PWM control is conducted. The output from the multiplexer 104 is output to the switching device via the output section 105.

FIG. 14 is a block diagram of a conventional switching control circuit that conducts a current mode of control. The current mode of control is different from the voltage mode of control in that the oscillation signal from the oscillator 102 is input to the PFM one-shot circuit 103 and a one-shot circuit 106 and the output signal from the one-shot circuit 106 is input to the multiplexer 104 via a flip-flop FF101 in the current mode of control. The current mode of control is different from the voltage current mode of control also in that the feedback signal VFB is compared by the PWM comparator CP102 with a detection signal VIS of the current flowing through the switching device and the output signal from the PWM comparator CP102 is input to the reset terminal of the flip-flop FF101.

Since the PWM control is conducted at the start of the conventional switching power supply that changes over the PFM control and the PWM control to each other, an over current flows through the switching device at the start of the switching power supply. Since the output voltage from the switching power supply is zero at the start thereof, the feedback signal VFB shows the maximum value, based on which the switching device conducts switching at the maximum ON-time ratio in the voltage mode. Since the period that elapses before the PWM comparator CP102 in FIG. 14 outputs the signal for switching OFF the switching device is the longest (or since the signal for switching OFF the switching device is not output depending on the power supply) in the current mode, the current flowing through the switching device increases monotonically.

References 1 through 3 do not describe anything on the problem described above or on the countermeasures for solving the problem described above. They also do not describe anything on the protection against short circuiting. In view of the foregoing, there remains a need for a switching power supply that can reduce power consumption at the standby mode. There also remains a need for a switching power supply that can prevent overcurrent, as well as preventing short-circuiting at the start thereof. The present invention addresses these needs.

### SUMMARY OF THE INVENTION

The present invention relates to a switching power supply and a method for controlling the same that conducts a PFM control and a PWM control, and more specifically to a switching power supply that can reduce power consumption in driving a light load.

One aspect of the present invention is a switching power supply that has a switching control circuit. The switching control circuit is configured to provides a PFM control of a switching device when a load is judged to be light based on a load signal that indicates weight of the load, and is configured to provide a PWM control of the switching device when the load is judged not to be light based on the load signal. The switching control circuit sets a minimum ON-period of the switching device when a predetermined condition is met during the PWM control, and the switching control circuit turns off the switching device when current flowing through the switching device exceeds an allowable value after an elapse of the minimum ON-period.

The minimum ON-period is shorter than an ON-period of the switching device in the PFM control. The predetermined condition can comprise at least one of the weight of the load judged from the load signal and exceeding a specified value, including a short-circuited output from the switching power supply, or a start of the switching power supply. The load signal can comprise at least one of an error signal indicating a difference between a detected value of an output voltage from the switching device and a first reference value or a detection signal indicating a detected current flowing through the switching device.

Another aspect of the present invention is a method of controlling the switching power supply having the switching control circuit described above. The method includes providing a PFM control of a switching device with the switching control circuit when a load is judged to be light based on a load signal that indicates weight of the load, providing a PWM control of the switching device with the switching control circuit when the load is judged not to be light based on the load signal, setting a minimum ON-period of the switching device with the switching control circuit when a predetermined condition is met during the PWM control, and turning off the switching device with the switching control circuit when current flowing through the switching device exceeds an allowable value after an elapse of the minimum ON-period.

### BRIEF DESCRIPTION OF THE DRAWINGS

FIG. 1 is a block diagram of a first embodiment of a switching control circuit that conducts a voltage mode of control according to the present invention.

FIG. 2 is a block diagram showing the circuit configuration according to the first embodiment that emphasizes on the start of the switching control circuit in the voltage mode.

FIG. 3 is a block diagram showing the circuit configuration according to the first embodiment that emphasizes the voltage operation mode of the switching control circuit under an overload.

FIG. 4 is a block diagram of a second embodiment of a switching control circuit that conducts a current mode of control according to the present invention.

FIG. 5 is a block diagram showing the circuit configuration according to the second embodiment that emphasizes on the start of the switching control circuit in the current mode.

FIG. 6 is a block diagram showing the circuit configuration according to the second embodiment that emphasizes on the current operation mode of the switching control circuit under an overload.

FIG. 7A is a circuit diagram showing a concrete example of the light-load judging section that generates the signal fed to an oscillator in the switching control circuits according to the first and second embodiments.

FIG. 7B is a circuit diagram showing a concrete example of the current-limiting-value setting section and the current judging section in the switching control circuits according to the first and second embodiments.

FIG. 7C is a circuit diagram showing a concrete example of the one-shot circuit triggered by a short pulse input in the switching control circuit according to the second embodiment.

FIG. 8 is a circuit diagram showing a concrete example of a third embodiment of a switching control circuit in the voltage mode according to the present invention.

FIG. 9 is a timing chart of the switching control circuit in the voltage mode according to the third embodiment.

FIG. 10 is a circuit diagram showing the concrete example of a fourth embodiment of a switching control circuit in the current mode according to the present invention.

FIG. 11 is a timing chart of the switching control circuit in the current mode according to the fourth embodiment.

FIG. 12 is a block circuit diagram of a conventional switching power supply.

FIG. 13 is a block diagram of a conventional switching control circuit that conducts a voltage mode of control.

FIG. 14 is a block diagram of a conventional switching control circuit that conducts a current mode of control.

### DETAILED DESCRIPTION

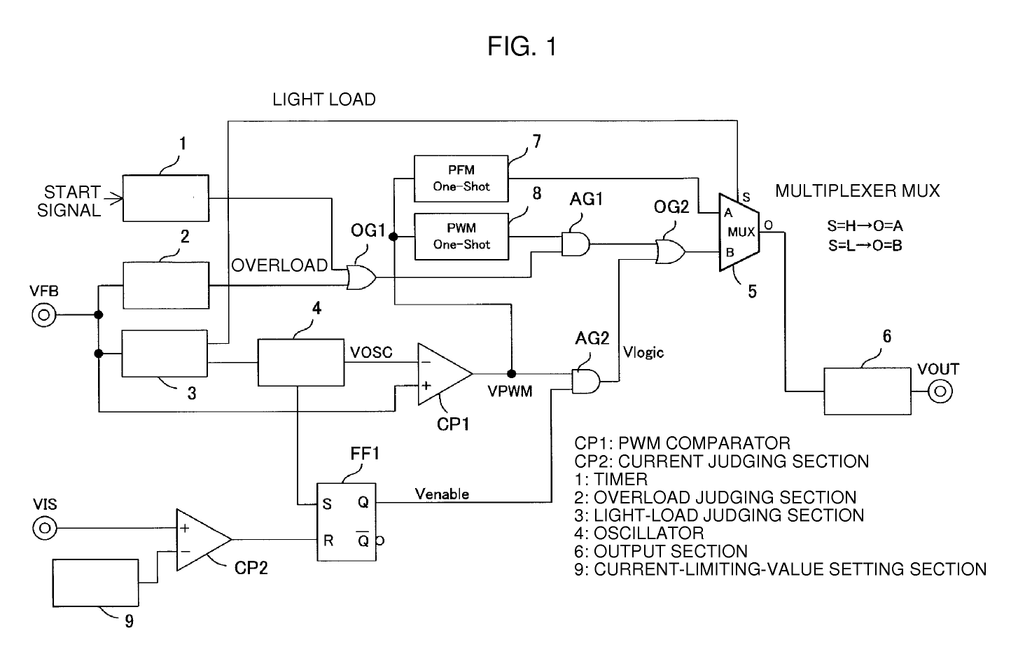

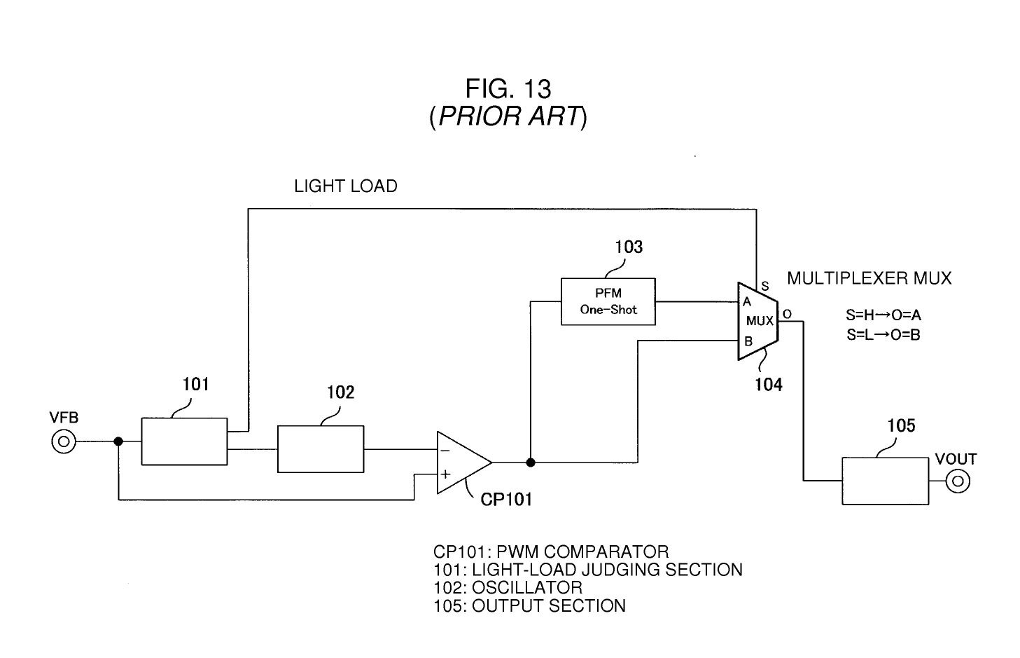

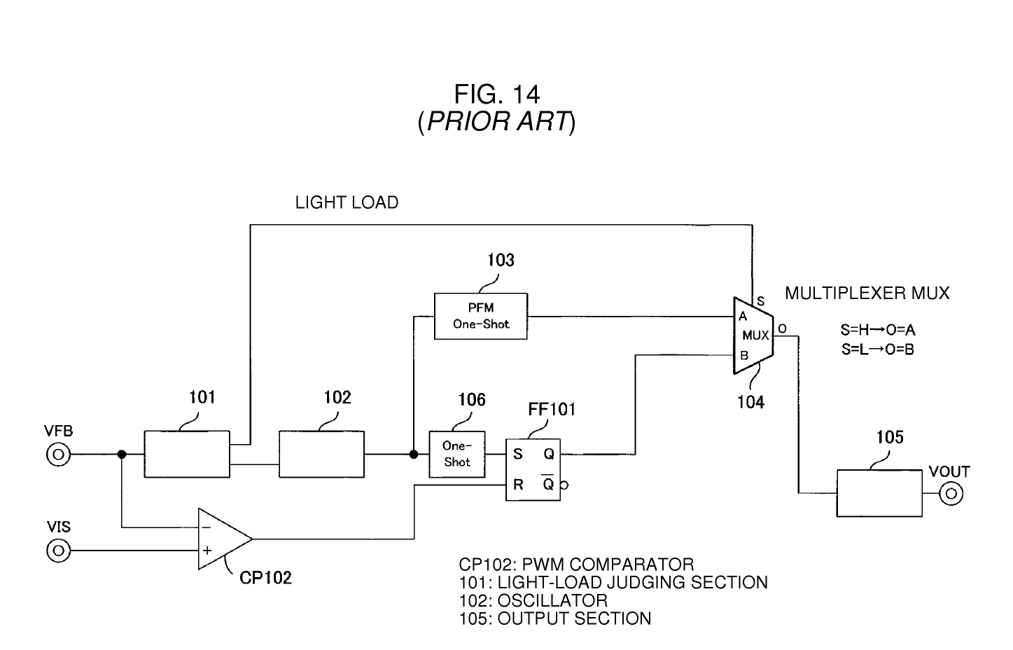

FIG. 1 shows the first embodiment of a switching control circuit in a full circuit configuration for the voltage mode. The switching control circuit includes a timer 1 that starts counting as a start signal is input thereto, an overload judging section 2 to which a feedback signal VFB is input, and a light-load judging section 3 to which the feedback signal VFB is input. The output signal from the light-load judging section 3 is input to an oscillator 4. An oscillation signal VOSC from the oscillator 4 and the feedback signal VFB are compared with each other by a PWM comparator CP1. The output signal VPWM from the comparator CP1 is input to a multiplexer 5 via gates AG2 and OG2. A switching device, which can be a power MOS transistor, can be controlled by the output signal VOUT from an output section 6 in the same manner as in the configuration shown in FIG. 13.

The output signal VPWM from the PWM comparator CP1 is input also to a PFM one-shot circuit 7 and a PWM one-shot circuit 8. The output signal from the PFM one-shot circuit 7 is input to the multiplexer 5. The output signal from the PWM one-shot circuit 8 is input to the multiplexer 5 via the gates AG1 and OG2. The gates AG1 and AG2 illustrated are AND gates, while the gates OG1 and OG2 are OR gates.

A detection signal VIS of the current flowing through the switching device can be, for example, the voltage generated across the current detection resistor connected between the source terminal of a power MOS transistor and the ground (GND) terminal, the output from a current transformer or the voltage across the inductor of the current transformer. The comparator CP2, which constitutes a current judging section, compares the detection signal VIS with the set value from a current-limiting-value setting section 9. The output from the comparator CP2 is output to a flip-flop FF1 as a reset signal. The enable signal Venable from the flip-flop FF1 is input to the AND gate AG2, while the output signal Vlogic from the AND gate AG2 is input to the OR gate OG2.

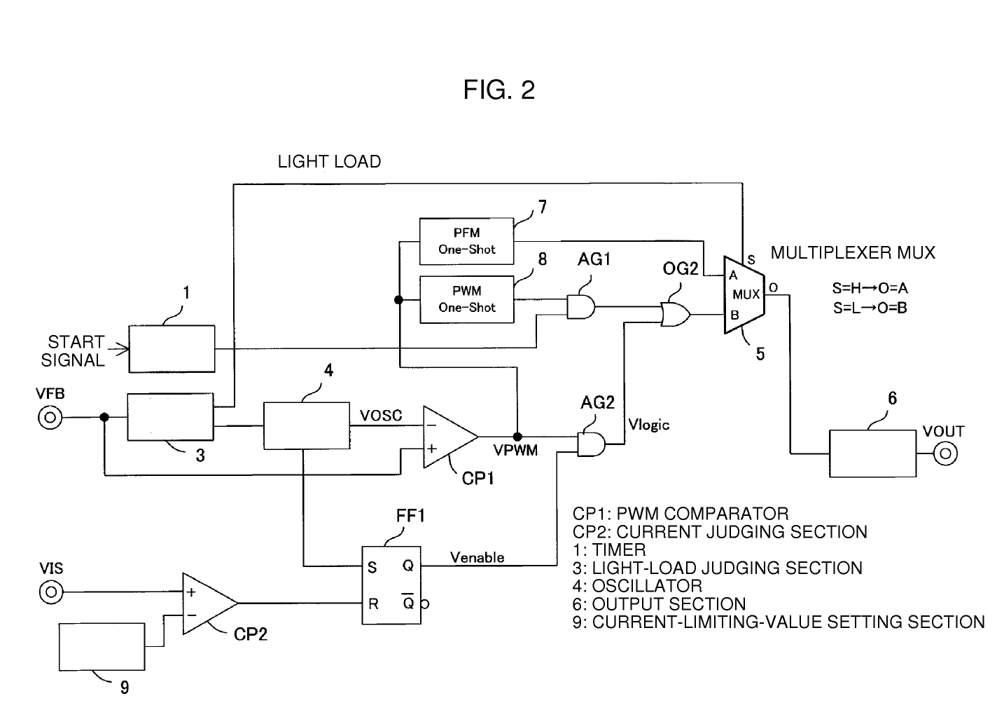

FIG. 2 is a block diagram showing the circuit configuration according to the first embodiment that emphasizes on the start of the switching control circuit in the voltage mode. At the start of the voltage mode, the timer 1 and the light-load judging section 3 operate. At the start of the voltage control mode, the overload judging section 2 shown in FIG. 1 is unnecessary, i.e., bypassed.

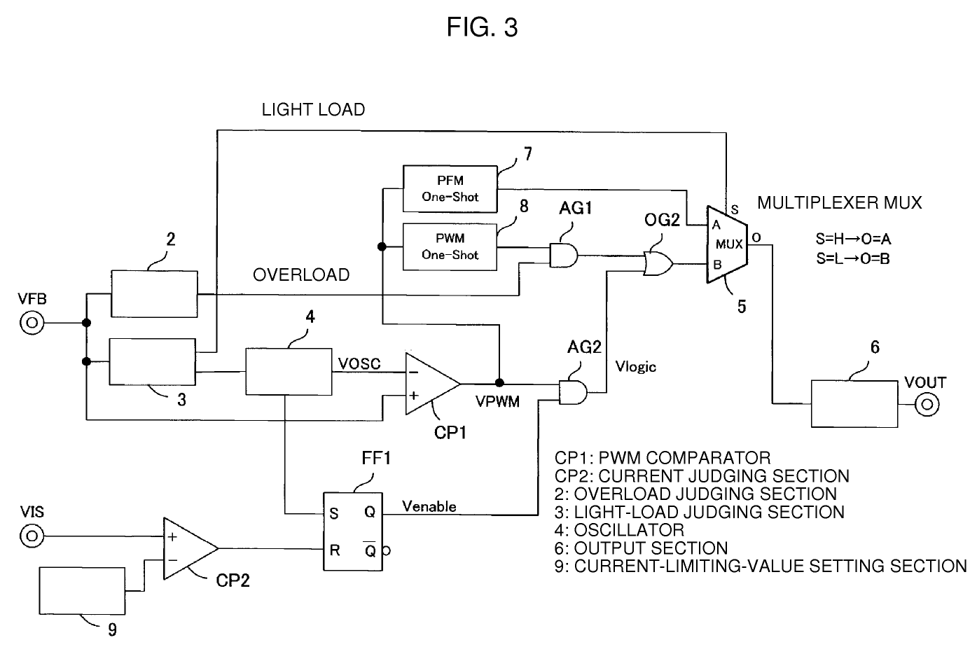

FIG. 3 is a block diagram showing the circuit configuration according to the first embodiment that emphasizes on the voltage operation mode of the switching control circuit while under overload. Under overload, the overload judging section 2 and the light-load judging section 3 operate. Under the overload, the timer 1 shown in FIG. 1 is unnecessary, i.e., bypassed.

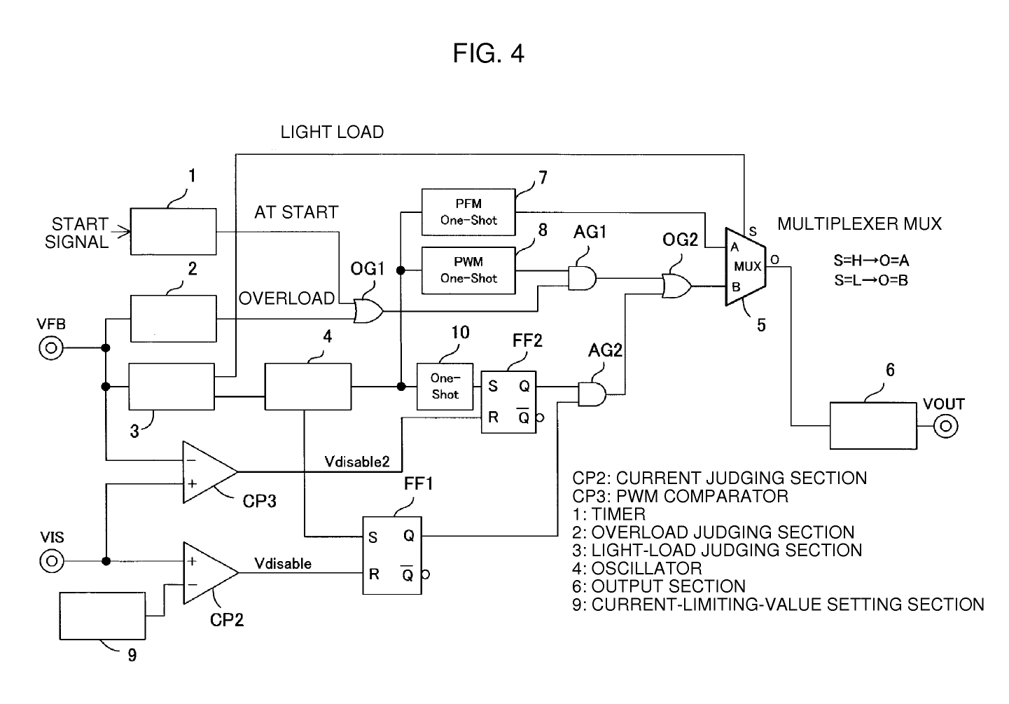

FIG. 4 shows the second embodiment of the switching control circuit in a full circuit configuration for the current mode. The second embodiment is different from the first embodiment as follows. In the second embodiment, the feedback signal VFB is compared with the current detection signal VIS of the current that flows through the switching device in a PWM comparator CP3 and the output Vdisable2 from the PWM comparator CP3 is input to a flip-flop FF2 as a reset signal. The oscillation signal from the oscillator 4 is input to the PFM one-shot circuit 7, the PWM one-shot circuit 8, and a one-shot circuit 10. The output signal from the one-shot circuit 10 is input to the AND gate AG2 via the flip-flop FF2. The remaining configuration is the same as the first embodiment.

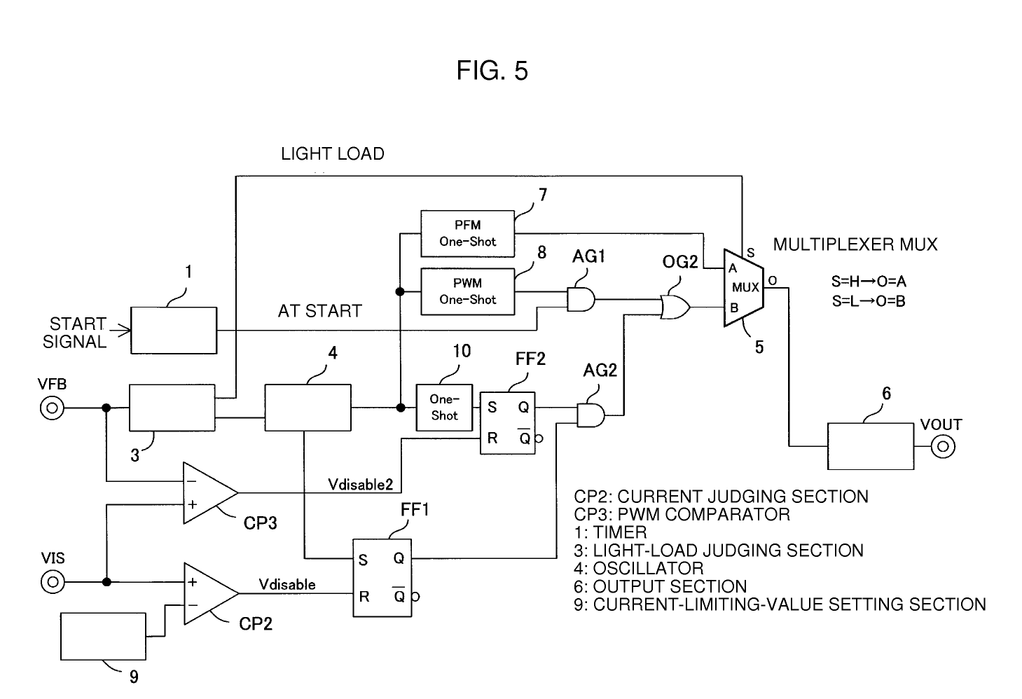

FIG. 5 is a block diagram showing the circuit configuration according to the second embodiment that emphasizes on the start of the switching control circuit in the current mode. At the start of the current mode, the timer 1 and the light-load judging section 3 operate. At the start of the current mode, the overload judging section 2 shown in FIG. 4 is unnecessary, as in the first embodiment.

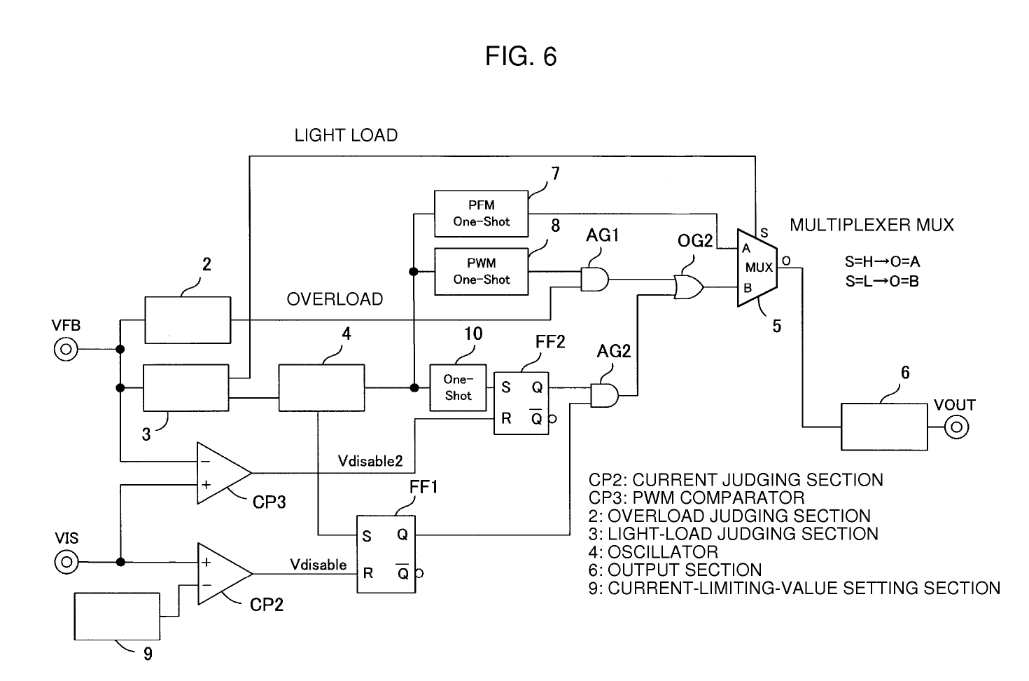

FIG. 6 is a block diagram showing the circuit configuration according to the second embodiment that emphasizes on the current operation mode of the switching control circuit under overload. Under overload, the overload judging section 2 and the light-load judging section 3 operate. Under overload, the timer 1 shown in FIG. 4 is unnecessary, as in the first embodiment.

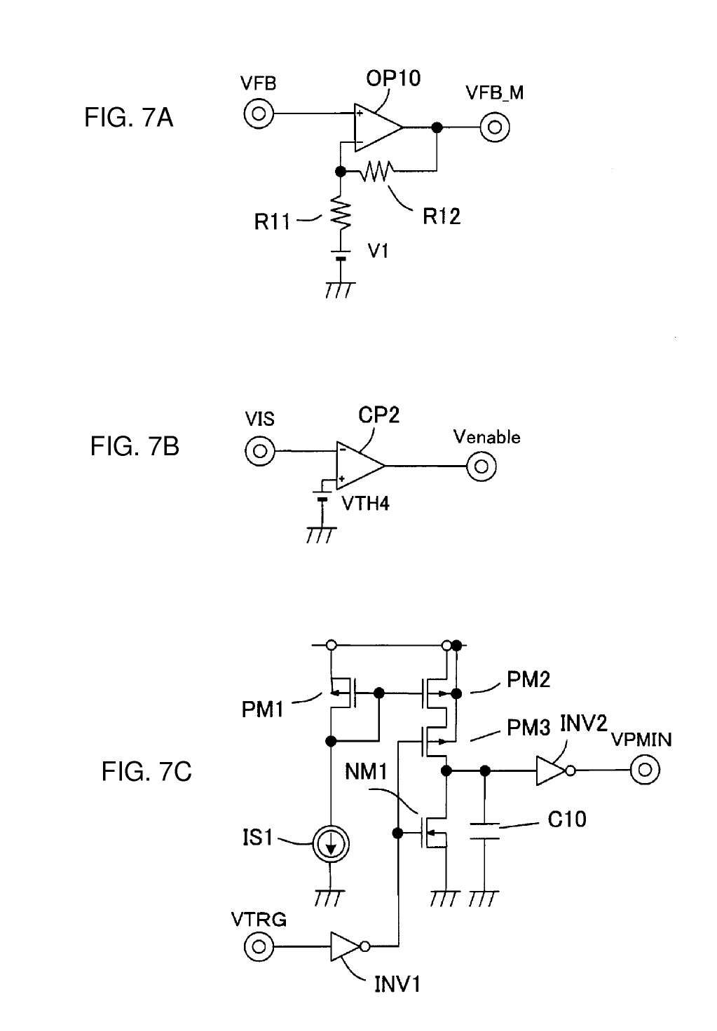

FIG. 7A is a circuit diagram showing a concrete example of a circuit configuration of the light-load judging section 3 that generates the signal fed to the oscillator 4 in the switching control circuits according to the first and second embodiments. The signal fed to the multiplexer 5 is generated by comparing the feedback signal VFB with a reference voltage in a comparator. FIG. 7B is a circuit diagram showing a concrete example of a circuit configuration of the current-limiting-value setting section 9 and the current judging section CP2 in the switching control circuits according to the first and second embodiments. FIG. 7C is a circuit diagram showing a concrete example of a circuit configuration of the one-shot circuit 10 triggered by a short pulse input in the switching control circuit according to the second embodiment.

Referring to FIG. 7A, the light-load judging section 3 converts the feedback signal VFB to an input voltage suited for the oscillator 4 with an operational amplifier 10, a reference voltage V1 and resistors R11, R12. The feedback signal VFB is converted to a signal where V1+(VFB−V1)×R12/R11.

Referring to FIG. 7B, the current judging section, which is formed of the comparator CP2, compares the detection signal VIS of the current that flows through the switching device with reference voltage VTH4 from the current-limiting-value setting section 9. The PWM comparator CP1 shown in FIG. 1 sets the ON-width of the driving pulse for driving the switching device by comparing the oscillation signal VOSC from the oscillator 4 with the feedback signal VFB and outputs a PWM pulse to a control logic. The control logic determines the pulse to be finally output from the PWM comparator CP1, the result of comparison in the current judging section CP2, the output signal from the timer 1, the output signal from the overload judging section 2, and the output signal from the light-load judging section 3. The control logic outputs the determined pulse to the output section 6, which is a buffer for an output terminal (hereinafter referred to as an “OUT terminal”). Independently of the negative feedback based on the feedback signal, the enable signal Venable is output from the current judging section CP2 to determine the PWM pulse width for protecting the switching device and such constituent parts.

Referring to FIG. 7C, the one-shot circuit 10 is formed of a circuit triggered by a trigger signal VTRG that generates a pulse signal having a certain time width (time constant). The one-shot circuit 10 outputs a signal with a high (H)-level in response to the trigger signal VTRG input (a short pulse with a low (L)-level) and a signal with the L-level after the time constant has elapsed. The flip-flop FF2 in FIGS. 4-6 keeps the L-level output from the one-shot circuit 10 until the next trigger signal VTRG is input to the one-shot circuit 10. The one-shot circuit includes a current supply IS1, inverters INV1, INV2, a capacitor 10, an N-channel MOS transistor NM1, and P-channel transistors PM1 through PM3. For inverting the logic of the trigger input to the one-shot circuit, the inverter INV1 can be omitted. Alternatively, one more inverter can be disposed in the front stage or the back stage of the inverter INV1. When the inverter INV1 is omitted or when one more inverter is added, the trigger signal is a short pulse with the H-level.

Alternatively, the one-shot circuit 10 can be configured in the form of a circuit triggered by the level change of an input signal. The one-shot circuit triggered by the input-signal level change is configured by a differentiating circuit, to which an input signal is input, and a time-constant circuit. If necessary, a wave-shaping circuit can be interposed between the differentiating circuit and the time-constant circuit such that the output from the differentiating circuit is shaped, and the shaped output from wave-shaping circuit is input to the time-constant circuit.

According to the illustrated embodiments, the one-shot circuit of a pulse input type or the one-shot circuit of a level input type is selected as the occasion demands. For example, the PFM one-shot circuit 7 and the PWM one-shot circuit 8 can be of the level input type in the first embodiment. In contrast, the PFM one-shot circuit 7, the PWM one-shot circuit 8, and the one-shot circuit 10 can be of the pulse input type in the second embodiment. It should be noted, however, that the switching control circuits can use different types of one-shot circuits from those described above.

The start signal input to the timer 1 is an output from the under-voltage-lockout circuit (UVLO) of the internal power supply, a power-ON reset signal, and such a signal that invert at the start and stop of the IC. The timer 1 delays only the rising edge but does not delay the falling edge. Therefore, a signal with the H-level appears in the output from the timer 1 at the time point, delayed for the delay time set in the timer 1 from the time point, at which the start signal indicating the start of the IC changes to the H-level. Conversely, the start signal changes to the L-level at the stop of the IC and the output from the timer 1 changes to the L-level simultaneously.

The switching control circuit configured as described above conducts the PFM control when the load from the load signal indicating the load weight of the switching power supply is judged to be light. The switching control circuit configured as described above conducts the PWM control when the load is judged to be not light. As a certain condition is met during the PWM control, the output from the OR gate OG1 is set at the H-level so that the minimum ON-period of the switching device made to function by the output pulse, which is output from the PWM one-shot circuit 8 and made to go through the AND gate AG1, can be set. As the current flowing through the switching device exceeds the allowable value to the higher side after the elapse of the minimum ON-period, the signal Venable is set to at the L-level and the switching device is turned OFF. The minimum ON-period of the switching device in the PWM control is shorter than the ON-period of the switching device in the PFM control. The reason for this will be described below. The predetermined condition described above includes the load weight judged, for example, from the load signal and exceeding the specified value (including the short-circuited output from the switching power supply) and the start of the switching power supply.

The minimum ON-period is set not to completely interrupt the output from the switching power supply but to feed the minimum electric power to the load even when the predetermined condition described above is met (in the abnormal state). When the minimum ON-period is too long, the effect of preventing overcurrent is reduced. For improving the protection effect against overcurrent when the predetermined condition described above is met (in the abnormal state), it is desirable to set the minimum ON-period to be the shortest but as long as necessary. The PFM control is employed in the light load region. For decreasing the switching loses under the light load, the switching frequency is lowered usually to be relatively low. Corresponding to this, the ON-period of the switching device in the PFM control is long to some extent. The ON-period is further elongated especially to further decrease the switching loses at the standby. When the minimum ON-period is equal to or longer than the above-described ON-period of the switching device in the PFM control, the effect of preventing overcurrent is not expected.

The load signal can be, for example, an amplified error signal obtained by amplifying the output from an error amplifier that detects the difference between the detected value of the output voltage from the switching power supply and a first reference value. Alternatively, the load signal can be the detection signal obtained by detecting the current that flows through the switching device. The load signal is compared with a second reference signal to judge whether the load is light or not. The load signal is compared with the second reference signal with a certain hysteresis between the load signal and the second reference signal.

According to the present embodiments, the minimum ON-period of the switching device is set when a predetermined condition is met during the PWM control and the switching device is turned off when the current flowing through the switching device exceeds the allowable value to the higher side after the minimum ON-period has elapsed. Therefore, electric power consumption in the standby mode is reduced, while preventing overcurrent and facilitating the protection against a short-circuit at the start of the switching power supply.

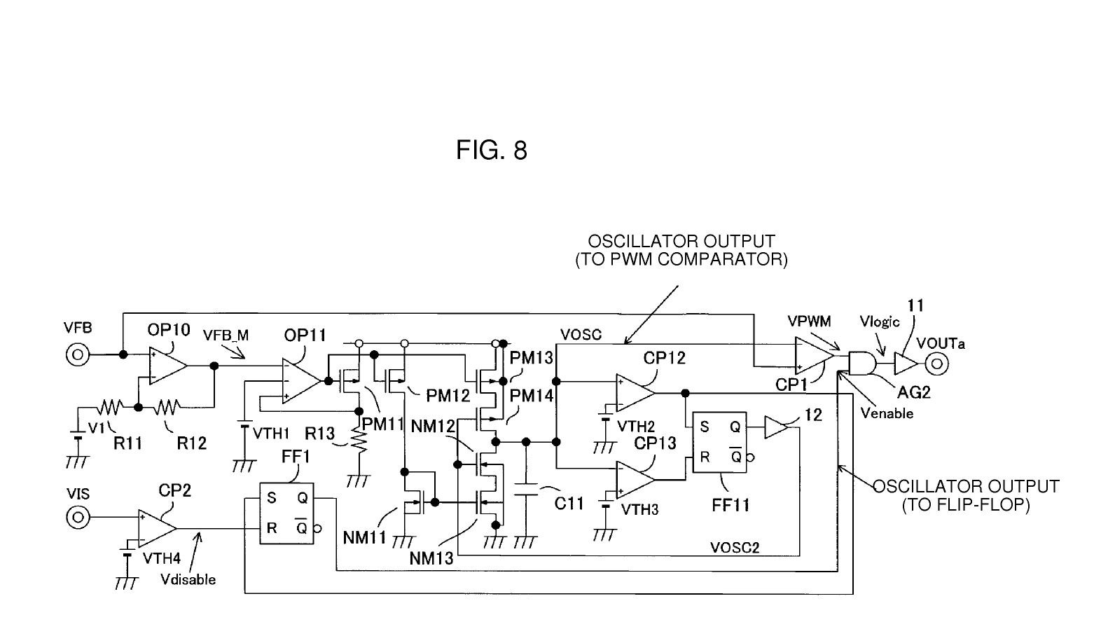

FIG. 8 is a circuit diagram showing the concrete exampled a switching control circuit in the voltage mode according to a third embodiment. The third embodiment includes an operational amplifier OP11 having three input terminals, into which a reference voltage VTH1 is input, a comparator CP12 into which a reference voltage VTH2 is input for comparison, a comparator CP13 into which a reference voltage VTH3 is input for comparison, a flip-flop FF11, P-channel MOS transistors PM11 through PM14, N-channel MOS transistors NM11 through NM13, a comparator CP11, and logic circuits 11, 12.

In determining the switching pulse frequency in the oscillator section, the current flowing through a resistor 13 on the output side of a comparator CP11 is set by the output signal from the operational amplifier OP11 that receives an output signal VFB_M from the light-load judging section (the output from an operational amplifier OP10). The operational amplifier OP11 having three input terminals functions as if the inverting input terminal thereof, to which lower one of the two input signals (output signal VFB_M from the light-load judging section OP10 and reference voltage VTH1) is input, and the non-inverting input terminal of the operational amplifier OP11 are short-circuited imaginarily. By the operation described above, the current flowing through the resistor 13 is determined by the reference voltage VTH1 or by the feedback signal VFB. The current flowing through the resistor 13 is converted to a discharging current of a capacitor C11 by the current mirror circuit including MOS transistors. Reference voltages VTH2 and VTH3 set the bottom and peak of the oscillating waveform and the comparators CP12 and CP13 monitor the voltage of the capacitor C11 to change over the charging and discharging of the capacitor C11.

The oscillator output VOSC has the waveform of the voltage across capacitor C11. The oscillator output VOSC2 has a rectangular waveform indicating the charging or discharging of capacitor C11. The operational amplifier OP11 is configured such that the lower one of output VFB_M from the operational amplifier OP10 and the reference voltage VTH1 is applied to the resistor 13 as described above. In this part of the switching control circuit, the oscillation frequency is changed in response to feedback signal VFB.

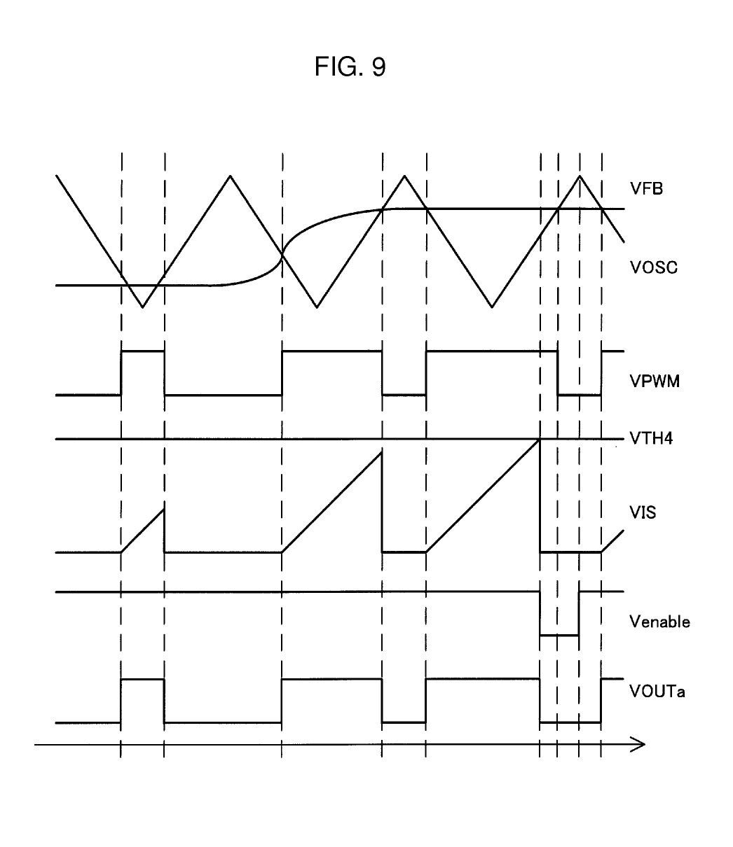

FIG. 9 is a timing chart of the switching control circuit in the voltage mode according to the third embodiment. In FIG. 9, the waveforms of the feedback signal VFB, the oscillator output VOSC, the output VPWM from the comparator CP1, the reference voltage VTH4, the detection signal VIS of the current flowing through the switching device, the enable signal Venable, and the output signal VOUTa are illustrated. As illustrated in FIG. 9, the switching power supply operates in the PWM mode at the start and the feedback signal VFB increases from half the way indicating that the load is becoming heavier. As the detection signal VIS reaches the reference voltage VTH4 in the final period illustrated in FIG. 9 and the flip-flop FF1 is reset, the enable signal Venable and the output from the AND gate AG2 are set at the respective L-levels. The enable signal Venable and the output from the AND gate AG2 set at the respective L-levels turn OFF the output signal VOUTa (set output signal VOUTa at the L-level).

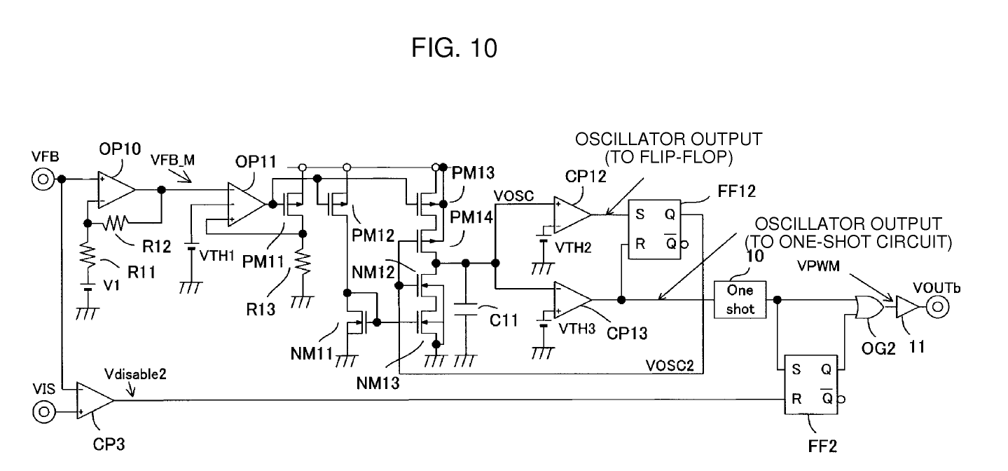

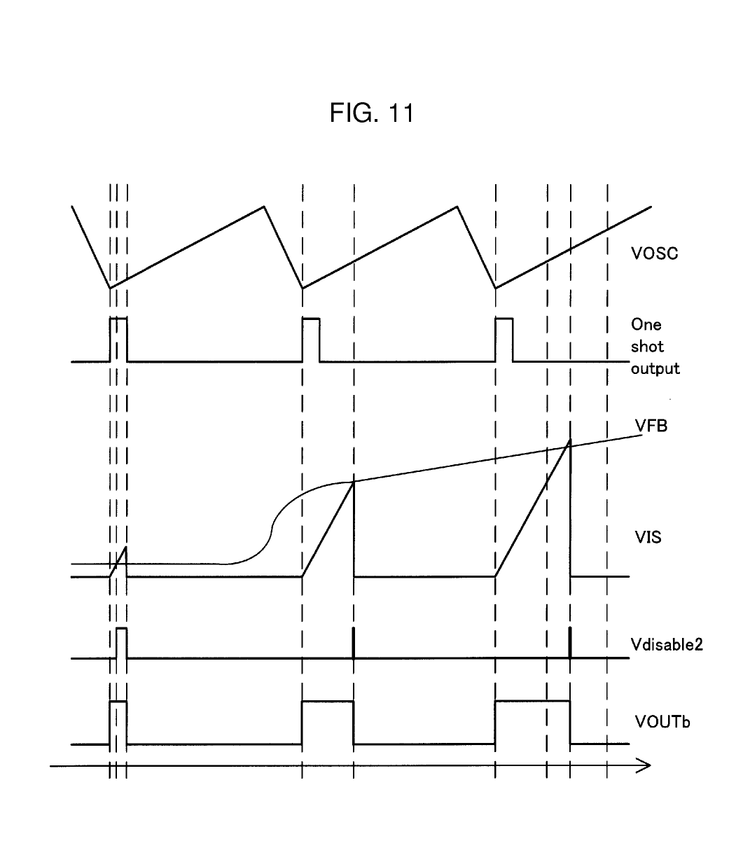

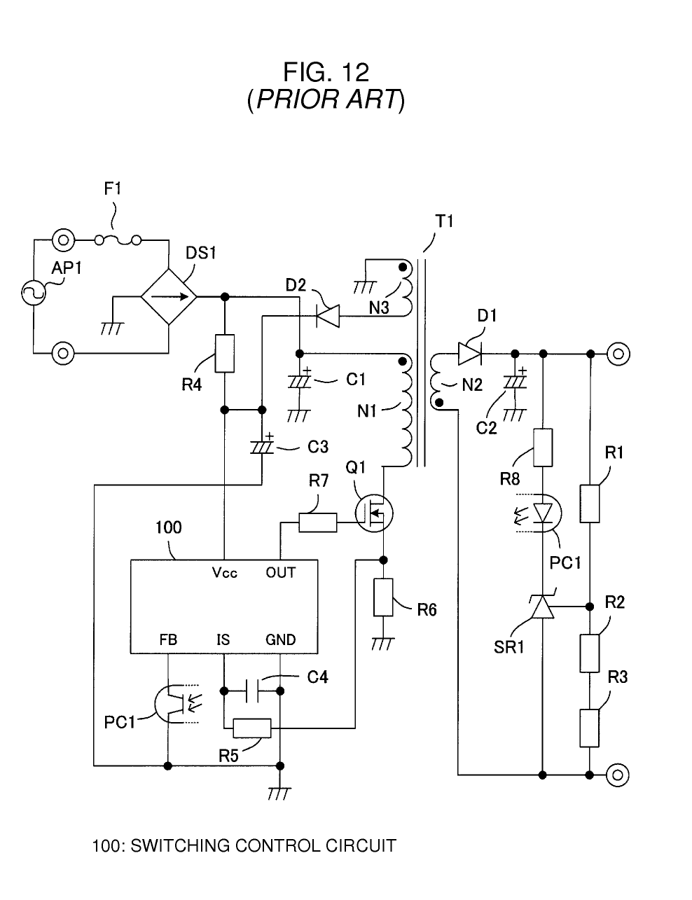

FIG. 10 is a circuit diagram showing the concrete example of a switching control circuit in the current mode according to a fourth embodiment. In FIG. 10, a flip-flop FF12 is shown. FIG. 11 is a timing chart of the switching control circuit in the current mode according to the fourth embodiment. The waveforms in the normal operations are illustrated in FIG. 11 but the waveforms in the operations conducted when the detection signal VIS reaches the reference voltage VTH4 as described in FIG. 9 are not illustrated in FIG. 11. The fourth embodiment includes the oscillator output VOSC, the output signal from the one-shot circuit 10, the feedback signal VFB, the detection signal VIS of the current flowing through the switching device, the output signal Vdisable from the comparator CP3, and the output signal VOUTb. The one-shot circuit 10 in FIG. 10 works also for the PWM one-shot circuit 8 in FIG. 4. The output signals VOUTa (FIG. 8) and VOUTb (FIG. 10) correspond to the output from the OR gate OG2 in FIG. 1 and the output from the AND gate AG2 in FIG. 4, respectively.

The switching power supply described herein can set the minimum ON-period of the switching device when a predetermined condition is met during the PWM control and turn off the switching device when the current flowing through the switching device exceeds the allowable value after the elapse of the minimum ON-period. This facilitates to reduce of electric power consumption in the standby mode, to prevent overcurrent at the start thereof, and to provide protection against short-circuiting.

While the present invention has been particularly shown and described with reference to particular embodiments, it will be understood by those skilled in the art that the foregoing and other changes in form and details can be made therein without departing from the spirit and scope of the present invention. All modifications and equivalents attainable by one versed in the art from the present disclosure within the scope and spirit of the present invention are to be included as further embodiments of the present invention. The scope of the present invention accordingly is to be defined as set forth in the appended claims.

This application is based on, and claims priority to, Japanese Patent Application No. 2007-018686, filed on 30 Jan. 2007. The disclosure of the priority applications, in its entirety, including the drawings, claims, and the specifications thereof, is incorporated herein by reference.

What is claimed is:

1. A switching power supply comprising:
a switching control circuit that provides a PFM control of a switching device when a load is judged to be light based on a load signal that indicates weight of the load, and provides a PWM control of the switching device when the load is judged not to be light based on the load signal,
wherein the switching control circuit sets a minimum ON-period of the switching device when a predetermined condition is met during the PWM control, and
wherein the switching control circuit turns off the switching device when current flowing through the switching device exceeds an allowable value after an elapse of the minimum ON-period.

2. The switching power supply according to claim 1, wherein the minimum ON-period is shorter than an ON-period of the switching device in the PFM control.

3. The switching power supply according to claim 1, wherein the predetermined condition comprises the weight of the load judged from the load signal and exceeding a specified value to a heavier side.

4. The switching power supply according to claim 2, wherein the predetermined condition comprises the weight of the load judged from the load signal and exceeding a specified value to a heavier side.

5. The switching power supply according to claim 1, wherein the predetermined condition comprises a start of the switching power supply.

6. The switching power supply according to claim 2, wherein the predetermined condition comprises a start of the switching power supply.

7. The switching power supply according to claim 1, wherein the load signal comprises an error signal indicating a difference between a detected value of an output voltage from the switching device and a first reference value.

8. The switching power supply according to claim 2, wherein the load signal comprises an error signal indicating a difference between a detected value of an output voltage from the switching device and a first reference value.

9. The switching power supply according to claim 1, wherein the load signal comprises a detection signal indicating a detected current flowing through the switching device.

10. The switching power supply according to claim 2, wherein the load signal comprises a detection signal indicating a detected current flowing through the switching device.

11. A method of controlling a switching power supply having a switching control circuit, the method comprising the steps of:
providing a PFM control of a switching device with the switching control circuit when a load is judged to be light based on a load signal that indicates weight of the load;
providing a PWM control of the switching device with the switching control circuit when the load is judged not to be light based on the load signal;
setting a minimum ON-period of the switching device with the switching control circuit when a predetermined condition is met during the PWM control; and
turning off the switching device with the switching control circuit when current flowing through the switching device exceeds an allowable value after an elapse of the minimum ON-period.
